(19) United States
(12) Patent Application Publication
(10) Pub. No.: US 2025/0058582 A1
(43) Pub. Date: Feb. 20, 2025

(54) A METHOD OF CREATING A TEXTURED LAYER ON A DECORATIVE PANEL

(71) Applicant: Unilin, BV, Wielsbeke (BE)

(72) Inventors: Lorenzo CORRADINI, Sassuolo (IT); Benny SCHACHT, Vlamertinge (BE)

(73) Assignee: Unilin, BV, Wielsbeke (BE)

(21) Appl. No.: 18/723,097

(22) PCT Filed: Dec. 16, 2022
(86) PCT No.: PCT/IB2022/062363

§ 371 Date: Jun. 21, 2024

(30) Foreign Application Priority Data
Dec. 22, 2021 (EP) 21217135.9

(51) Int. Cl. B44C 3/02; B41M 3/06; B44C 5/04

(52) U.S. Cl. CPC B44C 3/025; B41M 3/06; B44C 5/04

(57) ABSTRACT

A method of creating a textured layer on a film may involve supplying a film. A curable substance may be applied onto the film. Discrete quantities of a texturing fluid may be applied onto the curable substance through digital printing. At least a part of the curable substance may be subsequently cured.

This application claims priority under 35 USC § 119(a)-(d) from EP patent application number 212171359, which was filed on Dec. 22, 2021, the entire content of which is incorporated herein by reference.

### BACKGROUND

### 1. Field

The present invention relates to a method of creating a textured layer on a decorative panel, for example floor, wall, ceiling or furniture panel.

### 2. Related Art

Known methods for creating a textured layer on a decorative panel, comprise the steps of applying a curable substance onto a surface of a panel, applying discrete quantities of a texturing fluid onto the curable substance through digital printing, subsequently curing at least a part of the curable substance.

### SUMMARY

With the aim of providing an accurate correspondence between the texture and a décor on the panel, the known method provides for a digital printing décor to be performed directly on the panel, preferably immediately before the step of applying the curable substance.

An object of the invention is to provide an improved method of creating a textured layer on a panel.

This object is accomplished by the invention. According to its first independent aspect the invention relates to a method for manufacturing a textured film, wherein said film is adapted to be used in decorative panels, wherein the method comprises a step of providing a film and a step of applying a curable substance onto the film.

The method of the invention has the characteristic that the film can be according to one or more of the solutions described below.

According to a first solution of the invention a decor is provided onto the film.

An advantage of the invention is that it provides the opportunity to manufacture a textured film including the decor as an integral intermediate product, which can be attached to a substrate so as to form a panel. In this way the décor provided film can be manufactured with cheaper technologies compared to direct printing onto the panel and it is possible to reduce the risk of occurring of printing defects during manufacturing of the panel.

Furthermore, printing the texturing fluid through digital printing does not require expensive embossing tools, whereas printing in register with the decor is facilitated. In this way it is possible to combine the flexibility and variation of embossing tool free texturing methods with the efficiency provided by using decorated films.

In case of printing in register with the decor the resulting textured layer may have depressions and elevations which correspond to the haptic of the decor. Printing in register with the decor may be performed by applying image processing on the basis of the exposed decor or by using alignment marks which may have been provided on the film. Said alignment mark can be provided on the surface of the film having the décor, for example hidden into the décor, or on the opposite surface.

Preferably, the curable substance after curing is translucent such that a decorative pattern at a side opposite to the side where the textured layer is located is visible.

It is noted that preferably the curable substance can form a protective coating, preferably a wear protective coating, on top of said film to protect said décor.

The textured layer and/or the decor may imitate natural materials, for example imitating a wood, a stone or a cement material.

The curable substance may preferably a transparent or translucent substance.

The curable substance may be applied by means of inkjet printing, screen printing, roller printing, spraying, curtain coating or the like. In the preferred embodiment the curable substance is applied by means of coating techniques, preferably roller coating, in order to apply the curable substance relatively quickly. In practice, the curable substance may be a liquid or pasty substance.

The film and/or the curable substance may comprise a plastic composition, for example an acrylate-based plastic composition such as a polyurethane-modified acrylate plastic composition. The plastic composition may include a dipropylene glycol diacrylate and a reaction product of pentaerythritol, epichlorohydrin and acrylic acid. Additionally, it may comprise a catalyst, for example a tertiary ammonium salt, such as a tertiary ammonium salt selected from the group consisting of tetrabutly-ammonium bromide, methyl trioctylammonium chloride, benzyl triethylammonium chloride, hexadecyltrimethylammonium bromide and mixtures thereof. The catalyst may be tetrabutly ammonium bromide. Additionally the plastic composite may comprise a photoinitiator, for example a phosphine oxide, such as an aromatic phosphine oxide, e.g. phenylbis(2,4,6-trimethylbenzoyl)-phosphine oxide.

In a special embodiment, the film and the curable substance may have the same plastic composition such that after the step of curing they comprise substantially the same material.

In the preferred embodiment the film is in form of a flexible sheet.

Preferably the film can be made of a thermoplastic material, for example PVC, PP, PET, PE. In some embodiments, the film can be made of a curable substance, for example, of acrylic or polyurethane resin that is cured via Ultraviolet radiation.

In a practical embodiment the decor is provide onto one side of the film and the curable substance is applied onto the décor provided side thereof.

The decor may be provided onto the film by means of digital or analog printing. In particular digital printing provides great flexibility as to selecting a decorative pattern, whereas analog printing can be performed at relatively low cost.

Preferably the décor can be formed by pigment containing ink since pigments provides for higher lightfastness than other colorants like for example dyes. Said inks forming the décor base can be UV-cured ink, water-based inks, solvent-based inks or oil-based inks.

The texturing fluid may comprise a repellent material which repels the curable substance or a placeholder or mask which prevents the curable substance from being cured by means of radiation, whereas the step of curing is performed by means of radiation. The texturing fluid may comprise solid particles or a liquid or pasty substance, for example droplets. The liquid or the pasty substance may be solidified afterwards, for example via curing, preferably together with curing the curable substance. It is noted that if the texturing fluid is removed after the step of curing it does not need to have anti-wear properties.

The step of curing may be performed by means of UV radiation in order to polymerize the curable substance, more specifically via free radical polymerization. Nevertheless, alternative electromagnetic radiation is conceivable in order to initiate a chemical reaction such as polymerization or crosslinking. For example X-ray radiation, laser radiation, electron beam radiation, visible light, infrared, or the like. If curing is performed by means of UV light the curable substance may contain photo initiators for initiating free radical polymerization. In particular, mercury-free UV LEDs appear to be appropriate because of their advantageous penetration characteristics into the curable substance. In case of using electron beam radiation photo initiators are not required.

After the step of curing, any non-cured substance of the curable substance may be removed.

According to a second solution of the invention the film is a wear resistant film. A wear resistant film is also called a protective film and may be attached to a substrate in order to protect a surface of the substrate. This is particularly relevant if the substrate including the wear resistant film forms a floor panel. Attaching a wear resistant film to a substrate is advantageous with respect to applying a curable layer of the same thickness and curing the curable layer, since the wear layer can be manufactured at relatively low costs, whereas attaching the wear resistant film to the substrate requires relatively little manufacturing effort. The curable substance which is applied onto the wear resistant film is intended to create a textured layer and may be relative thin with respect to the wear resistant film.

The wear resistant film may be flexible and comprise protective properties such as stability, scratch resistance, heat resistance, water resistance and the like. Similarly, the textured layer may comprise protective properties such as stability, scratch resistance, heat resistance, water resistance and the like.

In this second solution it is particularly preferred that the wear resistant film has a refractive index that is the same of the refractive index of the curable substance.

Preferably the wear resistant film can be made of a thermoplastic material, for example PVC, PP, PET, PE. In some embodiments, the film can be made of a curable substance, for example, of acrylic or polyurethane resin that is cured via Ultraviolet radiation.

In an embodiment, the curable substance for forming the texture can be provided, for example coated or poured on a negative structure, for example on a mold or on a structured substrate, the structure of which can be formed using a digital technique, for example a 3D printing. The curable substance is then cured and removed from the negative structure. Preferably before curing the curable substance, the film is provided above the curable substance itself (on the face thereof that is opposite to the texture) and, in case the film is transparent to the curing radiation, the curable substance is irradiated through the film itself. In this case the curing can occur in inert condition thereby providing a harder texture.

The wear resistant film and/or the curable substance may be provided with particles of a hard material in order to obtain an appropriate abrasion-resistance, for example titanium nitride, titanium carbide, silicon nitride, silicon carbide, boron carbide, tungsten carbide, tantalum carbide, aluminum oxide (corundum), zirconium oxide, zirconium nitride or mixtures thereof.

In a particular embodiment of this second solution, the film is attached to a décor provided sheet or foil. Said décor provided sheet or foil preferably has one or more features in common with the décor provided film of the first solution.

In some embodiments an adhesion promoter substance can be provided between the wear resistant film and the décor provided film.

The invention is also related to a method of manufacturing a panel, which comprises the method of creating a textured layer on a film as described hereinbefore, wherein a thus formed textured film is attached to a substrate, hence forming the panel.

The textured film may be laminated to the substrate, preferably heat laminated or glued. In an alternative embodiment the film including the decor is attached to a substrate before the step of applying a curable substance onto the film. In some embodiments the textured film is provided on a panel that is provided with a profiled coupling element on one or more edges of the panel. This solution provides for an improved lamination or gluing of the film on the substrate. In fact, the stress that can be generated during milling or profiling can damage the bonding of the film on the substrate. This issue is avoided by first milling or profiling before attaching the film. It is noted that this effect is obtainable if the texture is provided first on the film and only after applied on the panel, because if the curable substance is provided directly on the panel, the substance itself can slip onto the coupling element thereby damaging it.

The film including the decor may be laminated to the substrate.

The invention is also related to a method of manufacturing a panel, which comprises the method of creating a textured layer on a film as described hereinbefore, wherein the decor is provided onto the film by attaching a substrate including the decor on an upper surface thereof to the film, wherein the decor is printed onto the substrate by means of digital or analog printing or wherein a decorative film which is attached to the substrate comprises the decor.

The decorative film may be manufactured by applying the decor onto a base film.

The decor may be printed onto the base film by means of digital or analog printing.

The base film may be made of paper layer, polyethylene, polypropylene or polyvinyl chloride.

The resulting panel may be suitable for a floor, wall or ceiling covering or alternative coverings. It may also be a panel that is suitable for furniture, or the like.

The substrate may be rigid or flexible such that the resulting panel is rigid or flexible, respectively. The substrate may be made of a wood-based material like MDF or HDF, or thermoplastic, preferably vinyl, for example WPC, SPC or LVT, metal, glass, stone, ceramic, textile, non-woven fabric, polymeric composite, mineral-based material like MgO, or the like. For example, the panel is provided with a profiled coupling element on one or more edges of the panel

If the decor is printed by means of a digital printing process it may be printed by using water-based inks, solvent based inks, oil based inks or UV curable inks.

### BRIEF DESCRIPTION OF THE DRAWINGS

The invention will hereafter be elucidated with reference to very schematic drawings showing embodiments of the invention by way of example.

FIG. 1 is an illustrative view, showing steps of an embodiment of a method of manufacturing a panel according to the invention.

FIG. 2 is an illustrative view, showing steps of an embodiment of a method of creating a textured layer on a wear resistant film.

FIG. 3 is a similar view as FIG. 2, but showing an alternative embodiment.

FIG. 4 is a similar view as FIG. 1, but showing an alternative embodiment.

### DESCRIPTION OF NON-LIMITING EMBODIMENTS

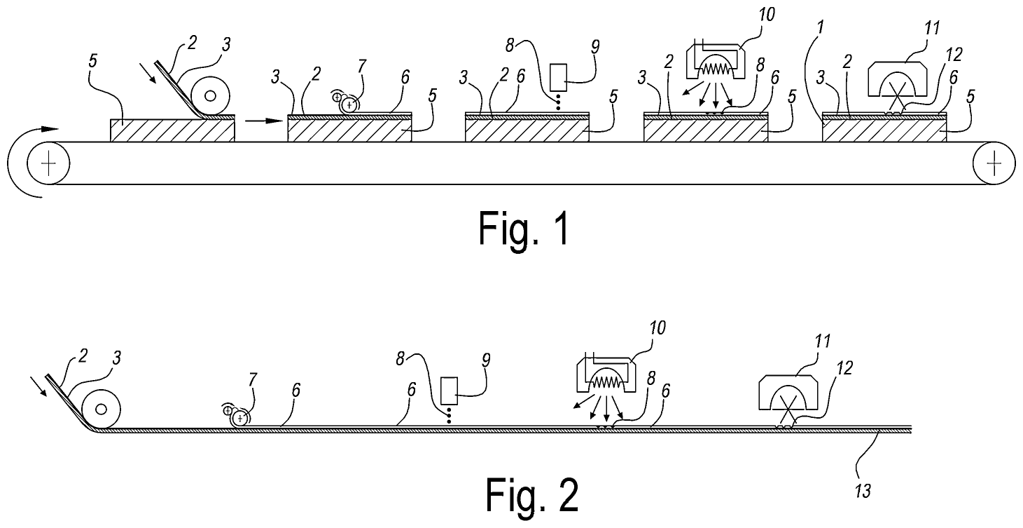

FIG. 1 illustrates successive steps of an embodiment of a method of manufacturing a panel 1 according to the invention.

At the upper left corner of FIG. 1 a flexible film 2 is laminated onto a substrate 5. The film 2 is a smooth, non-textured film provided with a printed décor 3 on its upper surface. Said décor 3 is formed using pigment containing inks and can be analog or digitally printed. The substrate 5 may be made of a wood-based material, a plastic-based material or mineral-based material, preferably it is made of PVC, for example SPC.

FIG. 1 further illustrates that a curable substance 6 is applied onto the film 2 by means of a roller 7. The curable substance 6 has anti-wear properties. On top of the curable substance 6 discrete quantities of a texturing fluid in the form of a mask 8 is printed by means of a digital mask printer 9. The mask 8 prevents the curable substance 6 from being cured by means of UV radiation. The mask 8 is printed in register with the decor 3. This may be facilitated by an image processing system (not shown) which digitalizes the decor 3 before the step of printing the mask 8, or that identifies aligning marks on the film 2.

In a next step the curable substance 6 including the mask 8 is exposed to a UV radiator 10. Consequently, the curable substance 6 outside the locations where the mask 8 is printed is cured. Subsequently the non-cured portion of the curable substance below the mask 8 and the mask 8 are removed by a mechanical device 11, for example a brushing device, hence forming the panel 1 including depressions 12 in register with the decor 3, as shown in the lower right corner of FIG. 1. The cured curable substance 6 forms a textured layer on the film 2. The cured curable substance 6 is transparent such that the decor 3 is visible through the textured layer and in this embodiment the curable substance forms a wear coating on top of the décor 3.

The invention is also related to a method of creating a textured layer on a film such that a textured film 13 is created as an intermediate product. FIG. 2 shows successive steps of an embodiment of this method. Similar to the embodiment as illustrated in FIG. 1, at the upper left corner of FIG. 2 the flexible, smooth, non-textured film 2, which is has a decor 3 on its upper surface is provided with the curable substance 6 upon the decor 3 itself by means of the roller 7. The mask 8 is printed on top of the curable substance 6 in register with the decor 3 by means of the digital mask printer 9. After the step of curing the non-cured portion of the curable substance below the mask 8 and the mask 8 are removed by the mechanical device 11, hence forming the textured film 13 including depressions 12 in register with the decor 3. The textured film 3 can be rolled up in a roller and stored. In a different manufacturing process the textured film 13 may be attached to a substrate (not shown) in order to create a panel, for example by means of a laminating process.

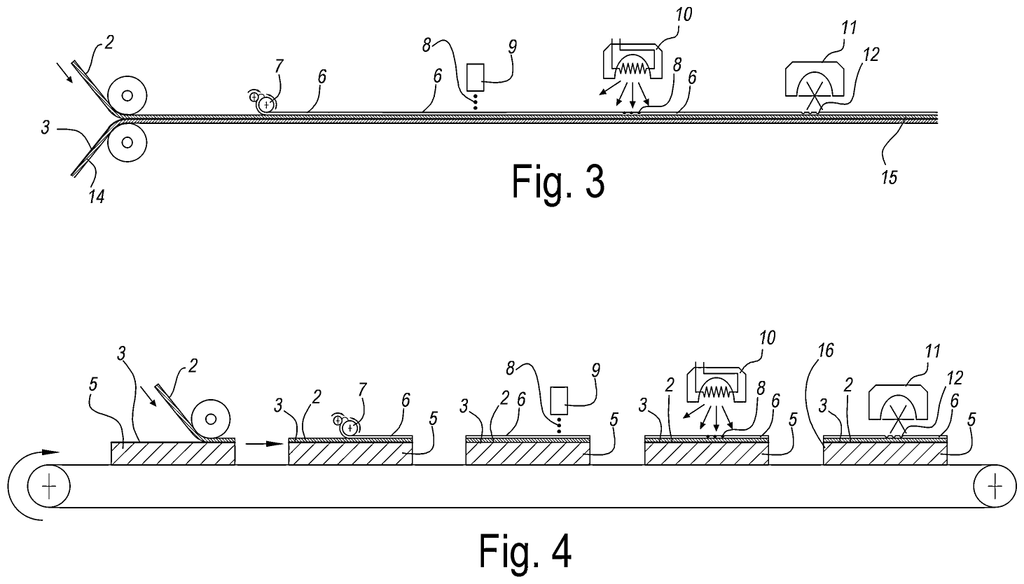

FIG. 3 illustrates successive steps of an alternative embodiment. At the upper left corner of FIG. 3 a flexible wear resistant film 2 and a decorative film 14 are supplied. The decorative film 14 comprises a base film onto which the decor 3 is printed by means of digital printing in a different manufacturing process (not shown). The wear resistant film 2 and the decorative film 14 are attached to each other, for example by means of glue, or preferably heat lamination. FIG. 3 shows that they are attached to each other such that the decor 3 is sandwiched between the wear resistant film 2 and the decorative film 14. Subsequent steps of applying the curable substance 6 and the mask 8, curing and removing non-cured substance and the mask 8 are similar to the embodiments as described hereinbefore. Finally, a textured wear resistant film 15 is formed, as shown in the lower right corner of FIG. 3. In a variant of the embodiment of FIG. 3, the decorative film 14 can be laminated onto a substrate 5 before being laminated to the film 2.

FIG. 4 illustrates successive steps of an alternative embodiment of the method of manufacturing a panel 16. At the upper left corner of FIG. 4 the substrate 5 is supplied. In a next step the decor 3 is directly printed onto the substrate 5 by means of the digital decor printer, after which the flexible, smooth, non-textured wear resistant film 2 is attached to the substrate 5 including the decor 3. Subsequent steps of applying the curable substance 6 and the mask 8, curing and removing non-cured substance and the mask 8 are similar to the embodiments as described hereinbefore. Finally, the panel 16 including depressions 12 in register with the decor 3 is obtained, as shown in the lower right corner of FIG. 4. In another alternative embodiment (not shown) a decorative film including the decor 3 may be attached to the substrate 5 instead of directly printing the decor 3 onto the substrate 5 by means of the digital decor printer 4.

The invention is further disclosed by the following item list.

1. A method of creating a textured layer on a film (2), comprising the steps of:
supplying a film (2),
applying a curable substance (6) onto the film (2),
applying discrete quantities of a texturing fluid (8) onto the curable substance through digital printing (9),
subsequently curing (10) at least a part of the curable substance (6).

2. The method according to item 1, wherein said film comprises a décor (3).

3. The method according to item 2, wherein the decor (3) is applied onto one side of the film (2), wherein the curable substance (6) is applied onto said side.

4. The method according to item 1, wherein the film (2) is a transparent or translucent film.

5. The method according to item 4, wherein a decor (3) is provided onto the film (2) by attaching a decorative film (14) comprising the decor (3) to the film (2).

6. The method according to any of the preceding items, wherein the film (2) is a smooth, non-textured film.

7. The method according to any of the preceding items, wherein the texturing fluid (8) comprises a repellent material which repels the curable substance (6) or a placeholder or mask (8) which prevents the curable substance (6) from being cured by means of radiation, whereas the step of curing is performed by means of radiation (10).

8. The method according to any one of the preceding items, wherein after the step of curing (10) any non-cured substance of the curable substance (6) is removed.

9. The method according to any of the preceding items, wherein the film is made of paper, polyethylene, polypropylene or polyvinyl chloride.

10. The method according to item 2 or 3 or any of items from 5 to 9, wherein the texturing fluid (8) is printed in register with the decor (3).

11. The method according to item 10, wherein the decor (3) is digitalized by means of image processing on the basis of which the texturing fluid (8) is printed or wherein aligning marks are applied on the film (2) which are used as reference coordinates for printing the texturing fluid (8).

12. A method of manufacturing a panel, comprising the method of creating a textured layer on a film (2) according to any one of the preceding items, wherein a thus formed textured film (15, 16) is attached to a substrate (5), hence forming the panel.

13. The method according to item 12, wherein the textured film (15, 16) is laminated to the substrate (5).

14. A method of manufacturing a panel (1), comprising the method of creating a textured layer on a film (2) according to any one of the items 1-11, wherein the film (2), preferably including the decor (3), is attached to a substrate (5) before the step of applying a curable substance (6) onto the film (2).

15. A method according to item 14, wherein the film (2) including the decor (3) is laminated to the substrate (5).

16. A method of manufacturing a panel (16), comprising the method of creating a textured layer on a film (2) according to item 1, wherein a decor (3) is provided onto the film (2) by attaching a substrate (5) including the decor (3) on an upper surface thereof to the film (2), wherein the decor (3) is printed onto the substrate (5) by means of digital printing or wherein a decorative film which is attached to the substrate (5) comprises the decor (3).

17. The method according to item 16, wherein the decorative film is manufactured by applying the decor (3) onto a base film.

18. The method according to item 17, wherein the decor (3) is printed onto the base film by means of digital or analog printing.

19. The method according to item 17 or 18, wherein the base film is made of paper layer, polyethylene, polypropylene or polyvinyl chloride.

20. The method according to any of items from 16 to 19, wherein the texturing fluid (8) comprises a repellent material which repels the curable substance (6) or a placeholder or mask (8) which prevents the curable substance (6) from being cured by means of radiation, whereas the step of curing is performed by means of radiation (10).

21. The method according to any of items from 16 to 20, wherein after the step of curing (10) any non-cured substance of the curable substance (6) is removed.

22. The method according to any of items from 16 to 21, wherein the texturing fluid (8) is printed in register with the decor (3).

23. The method according to item 22, wherein the decor (3) is digitalized by means of image processing on the basis of which the texturing fluid (8) is printed or wherein aligning marks are applied on the film (2) which are used as reference coordinates for printing the texturing fluid (8).

The invention is not limited to the embodiments shown in the drawings and described hereinbefore, which may be varied in different manners within the scope of the claims and their technical equivalents.

1. A method of creating a textured layer on a film, the method comprising:
supplying a film;
applying a curable substance onto the film;
applying discrete quantities of a texturing fluid onto the curable substance through digital printing; and
subsequently curing at least a part of the curable substance.

2. The method according to claim 1, wherein the film comprises a décor.

3. The method according to claim 2, wherein the decor is applied onto one side of the film; and
wherein the curable substance is applied onto the one side.

4. The method according to claim 1, wherein the film is a transparent or translucent film.

5. The method according to claim 4, wherein a decor is provided onto the film by attaching a decorative film comprising the decor to the film.

6. The method according to claim 1, wherein the film is a smooth, non-textured film.

7. The method according to claim 1, wherein the texturing fluid comprises a repellent material which repels the curable substance or a placeholder or mask which prevents the curable substance from being cured by means of radiation, whereas the step of curing is performed by means of radiation.

8. The method according to claim 1, wherein after the curing, any non-cured substance of the curable substance is removed.

9. The method according to claim 1, wherein the film is made of paper, polyethylene, polypropylene or polyvinyl chloride.

10. The method according to claim 2, wherein the texturing fluid is printed in register with the decor.

11. The method according to claim 10, wherein the decor is digitalized by means of image processing on the basis of which the texturing fluid is printed or wherein aligning marks are applied on the film which are used as reference coordinates for printing the texturing fluid.

12. A method of manufacturing a panel, the method comprising:
creating a textured layer on a film according to the method of claim 1 to form a textured film; and
attaching the textured film to a substrate.

13. The method according to claim 12, wherein the textured film is laminated to the substrate(S).

14. A method of manufacturing a panel, comprising:
creating a textured layer on a film according to the method of claim 1; and
wherein the film to a substrate before applying the curable substance onto the film.

15. A method according to claims 14, wherein the film including a decor is laminated to the substrate.

16. A method of manufacturing a panel, the method comprising:
creating a textured layer on a film according to the method of claim 1; and
providing a decor onto the film by attaching a substrate including the decor on an upper surface thereof to the film;
wherein the decor is printed onto the substrate by means of digital printing or wherein a decorative film which is attached to the substrate comprises the decor (3).

17. The method according to claim 16, wherein the decorative film is manufactured by applying the decor onto a base film; and
wherein the decor is printed onto the base film by means of digital or analog printing.

18. (canceled)

19. The method according to claim 17, wherein the base film is made of a paper layer, polyethylene, polypropylene or polyvinyl chloride.

20. The method according to claim 16, wherein the texturing fluid comprises a repellent material which repels the curable substance or a placeholder or mask which prevents the curable substance from being cured by means of radiation, whereas the curing is performed by means of radiation.

21. The method according to claim 16, wherein after the curing, any non-cured substance of the curable substance is removed.
